(19) United States
(12) Patent Application Publication
(10) Pub. No.: US 2007/0054246 A1
(43) Pub. Date: Mar. 8, 2007

(54) Method and system for teaching sound/symbol correspondences in alphabetically represented languages

(76) Inventors: Andrew Max Winkler, Ramona, CA (US); Barbara Sue Lawlor, Ramona, CA (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/220,530

(22) Filed: Sep. 8, 2005

(51) Int. Cl. G09B 19/00

(52) U.S. Cl. 434/156

(57) ABSTRACT

A system and method for teaching sound/symbol correspondences in alphabetically represented languages including selecting an alphabetic character string, choosing a tangible representation for a sound that the alphabetic character string is used to represent, and associating the tangible representation with the alphabetic character string based on the probability that the alphabetic character string is used in a written word to represent the sound represented by the tangible representation. In one embodiment, a sound is first selected, and an alphabetic character string is chosen that represents the sound. The alphabetic character string is associated with the sound based on the probability that the alphabetic character string is used in a word to represent the sound.

### BACKGROUND OF INVENTION

1. Field of the Invention

The present invention provides the means for a user to associate sounds to alphabetic characters without requiring any prerequisite literacy or knowledge of the alphabetic characters of an alphabetically represented language.

2. Discussion of the Background

In 1993, a report by the National Adult Literacy Survey released by the National Center for Educational Statistics, U.S. Dept of Education, indicated that more than 90 million Americans (48% of the nation's adult population) do not have functional literacy skills. The report also found that 22% of Americans have virtually no literacy skills and another 26% are at a level so low they can only sometimes read a road map. Colleges and Universities are reporting that it is common to find 30-40% of entering freshman reading below the 7th grade level. This problem has caused university systems in the West, Midwest and East to announce that they will discontinue remedial English classes and that the remediation of students' reading problems will have to be provided elsewhere.

The illiteracy problem in the United States and worldwide reflects the difficulties in transmitting universal literacy. Estimates indicate that 20-30% of the school population is experiencing moderate to severe reading dysfunction. These children remain learning disabled throughout school despite the efforts of reading specialists and tutors. Many of these children become juvenile delinquents, and then, incarcerated adults. The Correctional Education Association estimates that at least 60% of prison populations are either totally illiterate or have such a low literacy level that they cannot deal with the ordinary tasks of daily life. The United States already spends $350 billion a year on education and provides a wide array of free public education opportunities. The Senate Select Committee on Equal Education Opportunity concluded that the government spends $200 billion each year in attempts to overcome illiteracy. If we add in the costs of crime, productivity losses, equipment destruction and accidents that can be directly associated with illiteracy, the per capita costs of illiteracy are staggering.

Moreover, for the person who is even marginally illiterate, a broad world of activities and possibilities is closed off, and the person's safety may be at risk. Further, the feigning of literacy by one person may endanger others. Despite these obstacles faced by illiterate people, the huge amounts of money spent by the government, and the millions of volunteer and paid teacher hours devoted to the problem, all the efforts to correct reading problems have made only marginal progress at best and illiteracy rates remain high.

The beauty of written alphabetic language is that it allows the sounds of language to be reduced to simple symbols which can then be produced, manipulated or decoded by a reader or writer of the language, allowing communication through visual or tactile means alone, with no auditory component required. Basic instruction on how to associate the sounds of languages to our symbols for those sounds is what constitutes literacy education. However, complications arise as symbols become more abstract representations and multiple possible sound matches become associated with each symbol. Spellings tend to remain static, whereas a spoken language is constantly evolving resulting in a larger body of spelling rules, reading rules, and exceptions to those rules that the reader and writer must master in order to communicate in a written language. Researchers have observed that one of the major problems in teaching literacy is the lack of tangible and unambiguous representations of sounds. Means to represent sounds unambiguously do exist. One example is found in pending U.S. application Ser. No. 10/651,994, the entire contents of which are incorporated herein by reference. However, without having a means to bridge awareness of the sounds of words to their alphabetic representations, traditional literacy is not achieved and the great body of existing literature is inaccessible.

Research has shown that the number of items that can be held in short term memory at any one time is anywhere between five and nine items, with an average of about seven items. As mapping possibilities for each single word become more and more complex that capacity is quickly exhausted. The inability to simultaneously hold all of the phonetic possibilities for a single word in short term memory leads to frustration on the part of teachers and learners. That factor, along with the growing body of exceptions that have to be learned to master phoneme-grapheme correspondences have resulted in the “whole word” method of teaching literacy where each and every word must be memorized separately in order to be able to read and write. This method persists despite a growing body of evidence that clearly indicates that awareness of the individual sounds of language, often called phonemic awareness, is the most effective precursor to learning to read easily and is also the best predictor of reading proficiency throughout life. Even so, phonic instruction is not a panacea. Computer analysis of the frequency and distribution of sound possibilities associated with a given alphabetic symbol shows that in general people do not have a good intuitive sense of the sounds that alphabetic characters most commonly represent. Without a good understanding of how sound-letter correspondences actually work, phonetic instruction does little to provide useful learning strategies.

### SUMMARY OF THE INVENTION

Accordingly, one objective of the present invention is to provide a user with the means to independently acquire knowledge of the sounds associated with alphabetic characters without having prerequisite literacy.

Another objective of the present invention is to provide concrete manipulable representations of the mapping possibilities of sounds to alphabetic symbols, thereby promoting associative learning for a user not having any prerequisite literacy and having only limited access to electronic devices or already literate people.

Another objective of the present invention is to provide an electronic display and means for manipulating sound/symbol information to learn sound/symbol correspondences, thereby allowing independent learning with limited access to literate teachers required.

Yet another objective of the present invention is to provide an automatic means for learning the probabilities associated with various sound/symbol correspondences in order to make the “sounding out” process involved in phonetic reading easier and more efficient. Accordingly, learning could occur either through analytical work with the sound/symbol correspondence objects or through games which bring about more spontaneous learning.

Another objective of the present invention is to give literacy teachers effective tools for teaching literacy using phonic methods. Computer analysis of sound matching probabilities along with sound/symbol correspondence objects representing those probabilities provide a more meaningful way of conveying phonic knowledge.

Any of these and/or other objects may be achieved by one embodiment of the present invention which includes multi-dimensional objects such as multi-sided cubes or dice which can be manipulated by a user in order to learn sound/symbol correspondences. One side of the multi-sided object illustrates the traditional alphabetic character presented in a visual form, and the other sides of the multi-sided object show the various sound possibilities the alphabetic character is used to represent in an alphabetically represented language. For example, if there is a possibility that the letter can be “silent” in a significant number of words, one side of the multi-sided object will be blank. In this embodiment, the tangible representations of sounds would be in a visual form. The most probable sound/symbol correspondences are shown in ways that communicate probability without requiring any literacy skills. One example is that the number of sides of the multi-sided object showing the same tangible representations of the possible sounds associated with the alphabetic character would vary according to the probability that the alphabetic characters are used in a written word of an alphabetically represented language to represent the sound associated with the tangible representations. Further, for alphabetic characters having multiple sound possibilities, such as vowels in the English language, probabilities could be shown with a hierarchical numbering system indicating the most likely correspondence as number 1 and other probabilities sequenced as 2, 3, 4, 5, if that many sounds occur in a significant number of words in the language.

Another embodiment of the present invention includes multi-sided objects, such as multi-sided cubes or dice, which present information in a tactile form. For example, one side of the multi-sided object has the traditional alphabetic character in a tactile form that can be perceived both visually and tactilely, and the other sides of the multi-sided object have various tangible representations of sound possibilities of the alphabetic character in a tactile form. These tangible representations of sound could be perceived both visually and tactilely.

A further embodiment of the present invention includes displaying the alphabetic character or combination of alphabetic characters on a screen or other display device. The tangible representations of the sounds associated with the alphabetic character or combination of alphabetic characters are presented in a manner that visually associates the tangible representations with the alphabetic character or combination of alphabetic characters. Manipulation of sound possibilities and correspondences are done in this embodiment through electronic means. Probabilities could be shown as gradations in size with the largest of the tangible representations of possible sounds representing the most probable use of an alphabetic character or combination of alphabetic characters in an alphabetically represented language. Alternatively, a chart including the tangible representations and probability information could be displayed using the screen or other display device.

Another embodiment presents the alphabetic character in both visual and auditory form. The letter is shown as well as said. In this version, the possible sound associations are indicated with size gradations based on probability and presented auditorily in a way that conveys the probability of association. (e.g., varying loudness or instructions such as “first try “a” as in acorn, next try . . . ).

In still another embodiment, a method for teaching sound symbol correspondences in alphabetically represented languages includes selecting a sound and choosing from an alphabetically represented language an alphabetic character string used to represent the sound. The alphabetic character string is then associated with the sound based on a probability that the alphabetic character string is used in a word of the alphabetically represented language to represent the sound.

It is to be understood that both the foregoing general description of the invention and the following detailed description are exemplary, but are not restrictive, of the invention.

### BRIEF DESCRIPTION OF THE FIGURES

The above-described and/or other advantages of the invention will become more apparent and more readily appreciated from the following detailed description of the exemplary embodiments of the invention taken in conjunction with the accompanying drawings, where:

FIG. 1 is a flow chart representative of a method for using tangible representations of sounds to teach sound/symbol correspondences in alphabetically represented languages in accordance with one embodiment of the invention;

FIGS. 2-6 illustrate examples of the six sides of a multi-sided cube according to an exemplary embodiment of the present invention;

FIG. 7 illustrates an example of reading using an exemplary embodiment of the present invention; and

FIG. 8 is a flow chart representative of a method for teaching sound/symbol correspondences in alphabetically represented languages in accordance with one embodiment of the invention.

FIG. 9 illustrates a computer that may be used to implement the present invention.

### DETAILED DESCRIPTION OF THE INVENTION

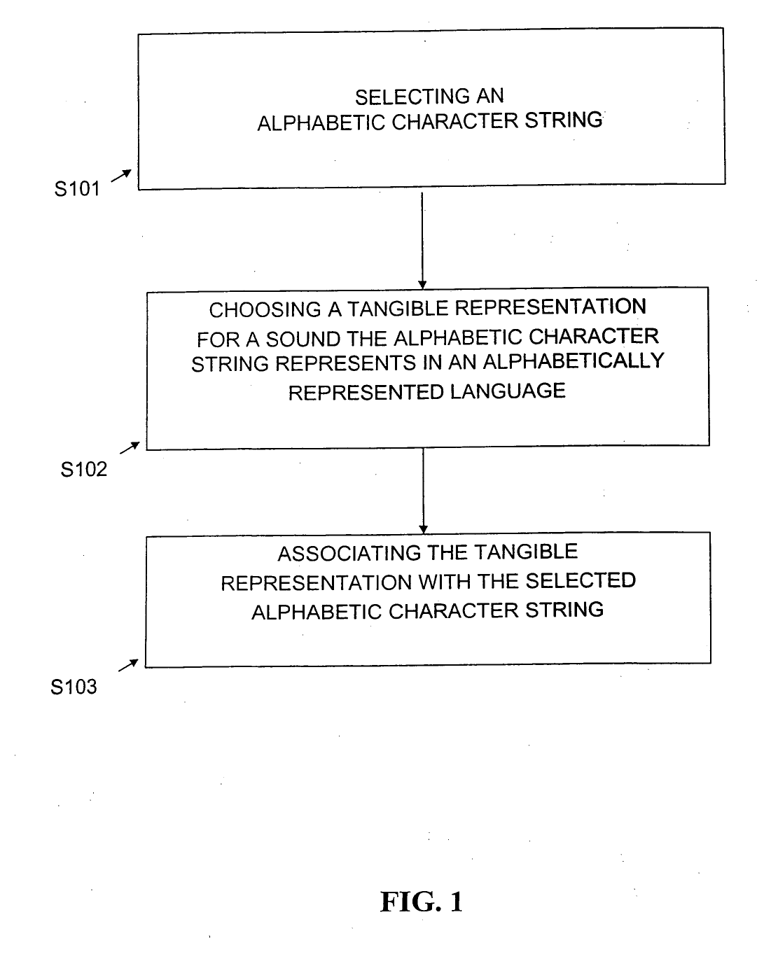

Referring now to the drawings, wherein like reference numerals designate identical or corresponding parts throughout the several views, FIG. 1 is a flowchart representative of a method for teaching sound/symbol correspondences in alphabetically represented languages in accordance with one embodiment of the present invention. The flowchart in FIG. 1 includes: step s101 of selecting an alphabetic character string from an alphabetically represented language; step s102 of choosing a tangible representation of a sound that the selected alphabetic character string is used to represent in the alphabetically represented language; and step s103 of associating the tangible representation with the alphabetic character string based on the probability that the alphabetic character string is used in a written word of the alphabetically represented language to represent the sound represented by the at least one tangible representation. As used herein, the term “alphabetic character string” means a single alphabetic character or a combination of two or more alphabetic characters used to represent a sound. Thus, the term “alphabetic character string” and “alphabetic character” are used interchangeably throughout this specification.

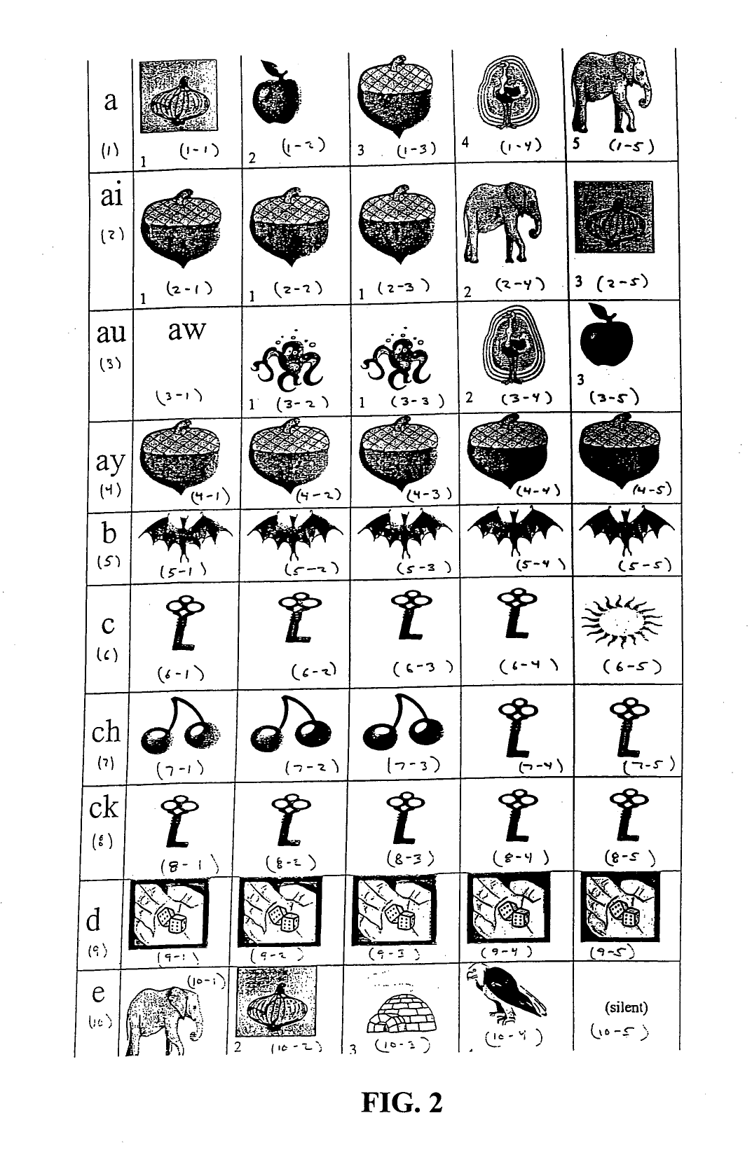

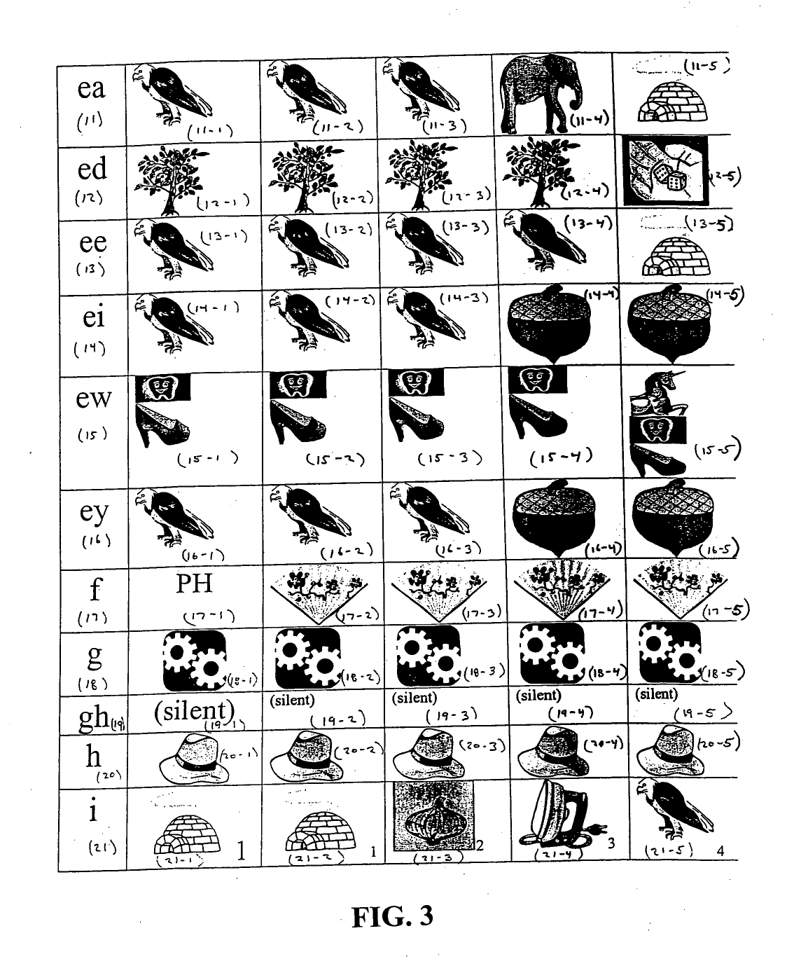

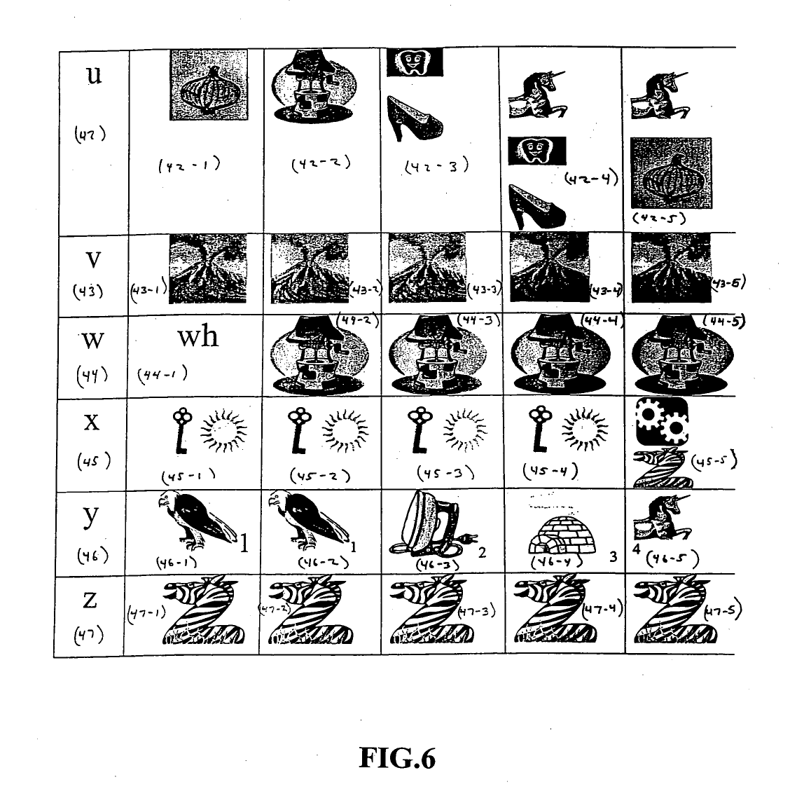

More specifically, in step s101 an alphabetic character or combination of alphabetic characters is selected from an alphabetically represented language. The exemplary embodiments of the present invention described herein are explained using English as the alphabetically represented language, but it is to be understood that any other alphabetically represented language (e.g., Spanish, French, German, etc.) could be used. Reference numerals (1-1)-(47-5) of FIGS. 2-6 represent exemplary examples of an alphabetic character or combination of alphabetic characters (i.e., letter or letter combination) which may be selected from the English language.

Reference numerals (1-1)-(47-5) of FIGS. 2-6 are non-limiting examples of tangible representations of sounds the corresponding letter or letter combinations alphabetic character or combination of alphabetic characters are used to represent in the alphabetically represented language. More specifically, reference numerals (1-1)-(47-5) of FIGS. 2-6 are tangible representations of sounds corresponding to a letter or letter combination used in the English language.

Learning to read and write an alphabetically represented language involves learning various properties of sound related to the alphabetic character or combination of alphabetic characters used in the language. For example, as illustrated in FIG. 2, the letter “b” (5) is used in the English language to represent the beginning sound of the word “bat”. The letter “b” (5) is a simple example since the letter “b” (5) is always used to represent a single sound in the English language. Accordingly, a single tangible representation is used to represent the letter “b” (5), and the single tangible representation representing the sound of the letter “b” (5) illustrated in FIG. 2 is a picture of a bat.

However, most alphabetic characters in an alphabetically represented language such as English are used to represent a plurality of different sounds. For example, the letter combination “ch” (7) may be used in the English language to represent the beginning sound of the word “cherry” or the beginning sound of the word “key”. Accordingly, as shown in FIG. 2, the tangible representations of the letter combination “ch” (7) are a picture of a cherry (7-1) and a picture of a key (7-4). This example illustrates that the tangible representation used to represent the sound of an alphabetic character or combination of alphabetic characters does not necessarily include the alphabetic characters in the spelling of the name of the tangible representation (e.g., “key” does not include the letter combination “ch”).

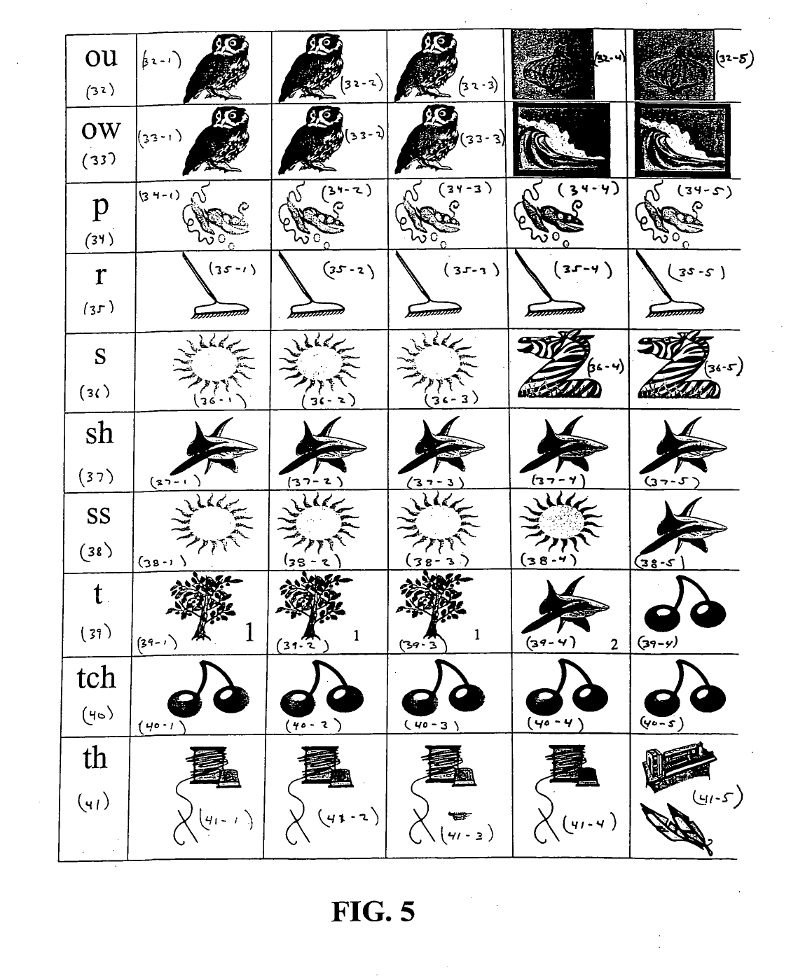

It is also noted that the same tangible representation can be used to illustrate a sound of two different alphabetic characters or combinations of alphabetic characters. For example, a picture of a cherry is used as a tangible representation of both the letter combination “ch” (7) and the letter combination “tch” (40) as shown in FIGS. 2 and 5.

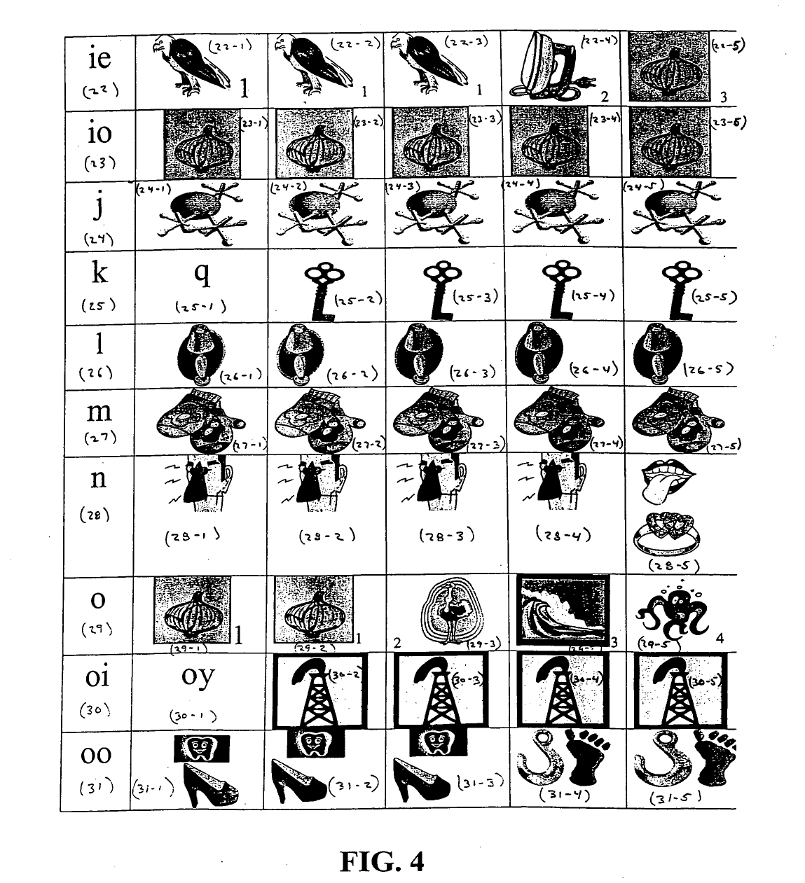

In many cases it is possible to reduce the tangible representation for expressing a particular sound to just one object. For example, the name of the chosen tangible representation provides the desired sound as the first sound of the name of the tangible representation (e.g., the picture of a “cherry” (7-1) used to represent a sound of the letter combination “ch” (7)). While it would be convenient to always be able to use just one picture for a tangible representation for each sound of an alphabetic character or combination of alphabetic characters, the typical structure of natural language does not allow for this situation at all times. In fact, some sounds are never used to start words or so rarely used initially that those few words that do start with the sound are not objects that can be readily represented by a recognizable tangible representation. For example, as shown in FIG. 4, the letter combination “oo” (31) has two pictures for each tangible representation of each sound that the letter combination “oo” (31) represents in the English language. More specifically, reference numeral (31-1) illustrates both a picture of a tooth and a picture of a shoe to represent the first sound of the letter combination “oo” (31), whereas reference numeral (31-4) references a picture of a hook and a picture of a foot as a tangible representation for the second sound that the letter combination “oo” (31) is used to represent in the English language. Accordingly, a user can identify the sound common to the two names of the two pictures (e.g., tooth and shoe) of the tangible representation and recognize the sound that the corresponding alphabetic character or combination of alphabetic characters (e.g. the letter “oo”) is used to represent in the alphabetically represented language (e.g., English).

As discussed in the background section, one of the most difficult aspects of learning how to read and write is determining what sound an alphabetic character or combination of alphabetic characters is used to represent in a written word. Computer analysis of the frequency and distribution of sound possibilities associated with a given alphabetic symbol shows that in general people do not have a good intuitive sense of the sounds that alphabetic characters most commonly represent. For example, in the English language, the most frequent sound that the letter “a” represents is the beginning sound of the word “onion”, a sound that is most commonly associated in traditional phonetic teaching of the short sound for the letter “u”, as in umbrella. Without a good understanding of the sound/symbol correspondences in an alphabetically represented language, reading and writing is very difficult. Therefore, the present invention is designed in part to provide users with a better understanding of the sound/symbol correspondences in alphabetically represented languages.

Accordingly, in one embodiment of the invention tangible representations are associated with alphabetic characters based on the probability that the alphabetic character is used in a written word of a language to represent the sound represented by the tangible representation. For example, the probability that the letter “b” (5) is used in a word of the English language to represent the first sound in the word “bat” is 1, meaning that the letter “b” (5) is always used to represent the initial sound of the word “bat” in the English language. As a second example, the letter “c” (6) is associated with tangible representations including a picture of a key (6-1) and a picture of a sun (6-5) based on the probability that the letter “c” (6) is used to represent the beginning sound of the word “key” and the probability that the letter “c” (6) is used to represent the beginning sound of the word “sun” in a written word of the English language.

According to one embodiment of the present invention, the tangible representations are associated with an alphabetic character or combination of alphabetic characters in a manner that easily conveys the probability that an alphabetic character or combination of alphabetic characters is used in a word to represent the sound the tangible representations are used to represent.

In one exemplary embodiment of the present invention, the associating step shown as step s103 in FIG. 1 is implemented by providing a multi-sided object with at least one alphabetic character on one side and at least one tangible representation of a sound of the alphabetic character illustrated on the other sides of the multi-sided object. For example, a multi-sided cube could be provided illustrating the letter “c” (6) on one side, a picture of a key (6-1) on a different side of the multi-sided cube, and a picture of a sun (6-5) on another side of the multi-sided cube.

FIGS. 2-6 illustrate non-limiting examples of the sides of multi-sided cubes used to easily convey the probability that the letters or letter combinations indicated as reference numerals (1)-(47) are used in the English language to represent the sounds identified by the tangible representations indicated as (1-1)-(47-5). For example, a multi-sided cube may have the letter “c” (6) arranged on one side of the multi-sided cube, a picture of a key (6-1)-(6-4) arranged on four other sides of the multi-sided cube, and a picture of a sun (6-5) arranged on the last remaining side of the multi-sided cube. Associating the tangible representations (i.e., the pictures of a key and sun) with the letter “c” (6) in this manner easily conveys the probability that the letter “c” is used a majority of the time in the English language to represent the beginning sound of the word “key”. More specifically, approximately four out of five times the letter “c” is used in the English language, the letter “c” represents the beginning sound of the word “key”.

However, letters such as the letter “a” are used to represent a larger number of sounds in the English language, and therefore require a larger number of tangible representations. For example the letter “a” (1) has five different tangible representations illustrated as (1-1)-(1-5). More specifically, the letter “a” (1) may be used to represent the beginning sound of the word “onion” (1-1); the beginning sound of the word “apple” (1-2); the beginning sound of the word “acorn” (1-3); the beginning sound of the word “ostrich” (1-4); and the sound of the third syllable of the word “elephant”. Therefore, the non-limiting example of a multi-sided cube corresponding to the letter “a” would have the letter “a” on one side and one of the tangible representations for each sound corresponding to the letter “a” on the remaining five sides of a multi-sided cube.

However, unless additional information is included on each side of a multi-sided cube corresponding to the letter “a” (1), no probability information is conveyed to the user. Therefore, according to this embodiment of the present invention, a number is included on each side of the multi-sided cube that includes a tangible representation. As illustrated in the non-limiting example of FIG. 2, the sides of the multi-sided cube correspond to (1-1) referencing a picture of an onion and the number 1, (1-2) referencing a picture of an apple and the number 2, (1-3) referencing a picture of an acorn and the number 3, (1-4) referencing a picture of an ostrich and the number 4, and (1-5) referencing a picture of an elephant and the number 5. According to this embodiment, the number 1 on the side of the cube corresponding to (1-1) conveys to the user that the letter “a” (1) most likely represents the beginning sound of the word “onion” when used in a written word of the English language, and therefore has the highest probability. Similarly, the number 2 on the side of the cube corresponding to (1-2) indicates the sound represented by the picture of the apple is the second most probable use of the letter “a” (1) in the English language. Alternatively, the calculated numerical probability indicating the letter “a” (1) is used to represent the sound associated with the tangible representation on the sides of a cube could be used to convey probability information to the user instead of the numbers 1, 2, 3, 4, and 5 representing the hierarchy of probability as discussed above and illustrated with respect to the letter “a” (1) in FIG. 2.

The alphabetic character and corresponding tangible representations included on the multi-sided cubes may be in the form of a visual representation or tactile representation. For example, the tangible representations illustrated as reference numerals (1-1)-(47-5) may be presented in a visual form by printing the pictures on the sides of the multi-sided cube or attaching stickers of the pictures on the multi-sided cubes. Alternatively, the tangible representations and alphabetic characters may be presented in a tactile form by indenting or raising the surface of the sides of the multi-sided cubes.

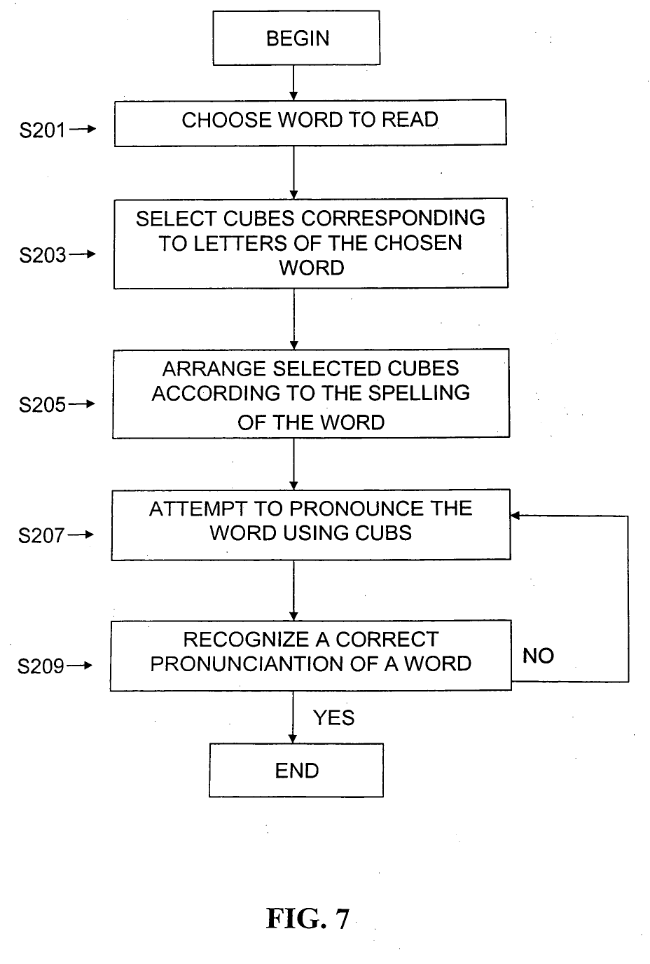

FIG. 7 illustrates a non-limiting example of how the multi-sided cubes of the embodiment discussed above could be used as a learning tool for teaching the sound/symbol correspondences of an alphabetically represented language, thereby aiding the process of learning to read or write. The method illustrated in the flow chart of FIG. 7 includes a step s201 of choosing a word to read; a step s203 of selecting multi-sided cubes corresponding to the letters or letter combinations used to spell the word; a step s205 of arranging the selected blocks to match the spelling of the word; a step s207 of attempting to pronounce the word using different combinations of the sounds represented by the tangible representations arranged on the different sides of the multi-sided cubes; and a step s209 of recognizing a correct pronunciation of a word. As shown in FIG. 7, steps s207 and s209 are repeated until a word is recognized in step s209.

The word “catch” is used as a non-limiting example further explaining the method illustrated in the flow chart of FIG. 7, wherein a person without any prerequisite literacy could use the multi-sided cubes according to FIGS. 2-6 to read a word in the English language. In this example a user is presented with multi-sided cubes corresponding to the alphabetic characters A-Z (1)-(47), and chooses the word “catch” to read in step s201. The user would select the multi-sided cubes corresponding to the letters or letter combinations in the word “catch” in step s203. Specifically, the user would select a cube corresponding to the letter “c” (6), a cube corresponding to the letter “a” (1), and a cube corresponding to the letter combination “tch” (40). In step s205, the user would arrange the multi-sided cubes to match the spelling of the chosen word “catch”. As previously discussed, approximately 4 out of 5 times the letter “c” (6) is used in the English language, the letter “c” (6) represents the sound at the beginning of the word “key”. Therefore, the user should begin attempting to pronounce the word “catch” using the sound corresponding to the beginning of the word “key”. Further, as discussed above, the most common sound the letter “a” (1) is used to represent in the English language is the beginning sound of the word “onion”, and therefore the user should begin attempting to pronounce the letter “a” in the word “catch” using the beginning sound of the word “onion”. As shown in FIG. 5, the letter combination “tch” is almost always used to represent the beginning sound of the word “cherry”. Therefore, in step s207, the user should begin attempting to pronounce the word “catch” by combining the beginning sound of the word “key”, the beginning sound of the word “onion”, and the beginning sound of the word “cherry”. However, the user should find that this pronunciation does not correspond to a word that the user is familiar with in the English language in step s209.

Therefore, the user should use a tangible representation of a different sound for one of the letters, and then attempt the pronunciation process again. For example, the user should use the tangible representation corresponding to the second most probable use of the letter “a” (1) in the English language. Therefore, the user should attempt to pronounce the word “catch” again this time using the beginning sound of the word “key” for the letter “c”, the beginning sound of the word “apple” for the letter “a”, and the beginning sound of the word “cherry” for the letter combination “tch”. This pronunciation by the user should result in the user recognizing the word “catch”. This is just one example of how associating a tangible representation of a sound with an alphabetic character or combination of alphabetic characters based on probabilities may aid a user in learning how to read and write.

Further, the embodiment of the present invention described above with respect to the multi-sided cubes may be implemented in a game designed for both learning how to read and entertainment purposes. For example, the user may choose a word to read (S201) by selecting a card from a game deck. The user can then be timed to see how long it takes the user to recognize the correct pronunciation of the word in step S203-S209. A reverse side of the selected card can include a pictoral representation of the word to confirm that the user has identified the correct word. Users can compete for best times and/or points in this embodiment of the invention.

As another example, a user could select a specified number of multi-sided cubes according to the non-limiting example of FIGS. 2-6 of the present invention. The selected number of multi-sided cubes could then be used to form words in a method similar to the process described above with respect to the flow chart of FIG. 7. Points could then be awarded to the user based on the probabilities of the sounds the letters represent in the assembled words and the total number of assembled words. For example, a user may be awarded more points for using the letter “c” (6) in a word to represent the sound corresponding to the beginning sound of the word “sun” (e.g. the player may spell the word “ace”), and less points for using the letter “c” in a word to represent the sound corresponding to the beginning sound of the word “key” (e.g. the player may spell the word “cat”).

In a second exemplary embodiment of the present invention, the associating at least one tangible representation with the at least one alphabetic character based on the probability that the at least one alphabetic character is used in a written word to represent the at least one sound represented by the at least one tangible representation is done electronically and is displayed on a screen or other display device. For example, the letter “c” may be displayed on a screen in combination with the tangible representations (i.e., a picture of a key and a picture of a sun) of the sounds that the letter “c” is used to represent in the English language. The probability that a letter is used in a word in the English language to represent a sound corresponding to a tangible representation associated with the letter can be visually conveyed to a user via an electronic display in a variety of manners. For example, the size of the tangible representation associated with the most common sound the letter is used to represent could be larger than the tangible representation of the less common sounds, thereby indicating that there is a higher probability that the letter is being used in the English language to represent the sound associated with the larger tangible representation. For example, since the letter “c” is most commonly used in the English language to represent the beginning sound of the word “key”, a picture of a key could be displayed next to a smaller picture of a sun.

Alternatively, the tangible representations and probability information may be conveyed to the user in the form of a chart on a screen or other display device. For example, the screen may display a pie chart divided into sections, wherein the size of the sections are indicative of the probability that the selected letter or letter combination is used in a language to represent the sound indicated by a tangible representation.

Another embodiment presents the alphabetic character in both visual and auditory form. The embodiments discussed above explained how the alphabetic characters, tangible representations of sounds associated with the alphabetic characters, and probability information can be easily conveyed to a user in a visual form, and therefore will not be repeated in the description of this embodiment. However, in this embodiment, the probability information is also conveyed in auditory form. For example, the sound associations indicating probability may be conveyed using varying loudness, varying repetitions, or sequential information (i.e. “first try “a” as in apple, second try “a” as in acorn, next try . . . ). Combining the auditory form with the visual forms discussed above with respect to the previous embodiments may further aid the process of learning the sound/symbol correspondences of an alphabetically represent language.

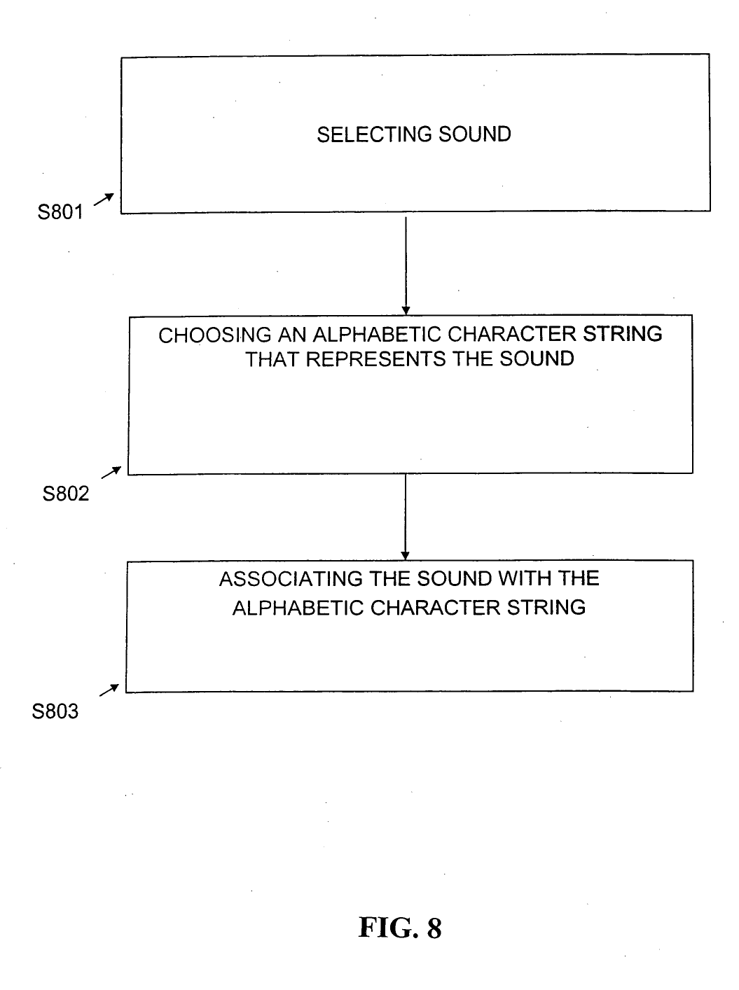

FIG. 8 is a flow chart representative of a method for teaching sound symbol correspondences in alphabetically represented languages in accordance with another embodiment of the present invention. The embodiment of FIG. 8 is similar to the embodiment of FIG. 1 except that, in FIG. 8, the initial selection is of a sound rather than an alphabetic character string. Thus in step s801, a sound is selected, and in step s802 an alphabetic character string is chosen that represents the sound. The sound may be selected based on an audible rendering of the sound, or a tangible representation of the sound such as those described in FIGS. 2-6. In step s803, the alphabetic character string is associated with the sound.

The selected sound in step s801 can be associated with a plurality of alphabetic character strings based on the probability that an alphabetic character string would be used in a word of the alphabetic language to represent the sound. In this regard, it is noted that a plurality of different character strings can represent the same sound. For example, the alphabetic character strings “ch” and “tch” can each represent the beginning sound of the word “cherry”. These character strings may be associated with the sound in step s803 based on the probability that they represent the sound in any of the ways previously described with respect to FIGS. 1-7. For example, the character strings may be repeated on sides of a cube or displayed in a different sizes based on their probability. Thus, all aspects of the embodiments of FIGS. 1-7 wherein an alphabetic character string is first selected can be implemented in the embodiment of FIG. 8 wherein a sound is first selected. In addition, the embodiment of FIG. 8 may be implemented in a learning game such as that described in FIG. 7, or any other learning game or learning tool described in FIGS. 1-7. For example, rather than selecting a written word and arranging cubes to spell the word as described in FIG. 7, one could select a spoken word and arrange cubes having tangible representations of sounds thereon to phonetically represent the word. Character strings on the cubes can then be selected in order to obtain a proper spelling of the word.

Embodiments of the present invention may be implemented using a conventional general purpose computer or micro-processor programmed according to the teachings of the present invention, as will be apparent to those skilled in the computer art. Appropriate software can readily be prepared by programmers of ordinary skill based on the teachings of the present disclosure, as will be apparent to those skilled in the software art.

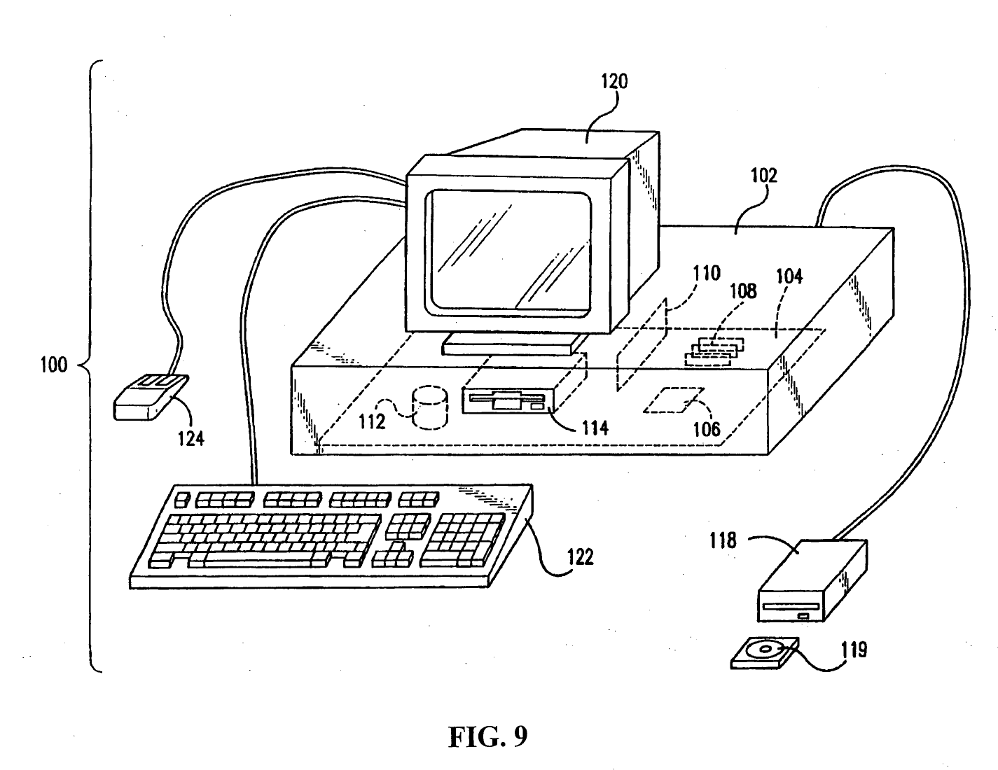

A non-limiting example of a computer 100 as shown in FIG. 9 may implement the method of the present invention, wherein the computer housing 102 houses a motherboard 104 which contains a CPU 106, memory 108 (e.g., DRAM, ROM, EPROM, EEPROM, SRAM, SDRAM, and Flash RAM), and other optical special purpose logic devices (e.g., ASICS) or configurable logic devices (e.g., GAL and reprogrammable FPGA). The computer 100 also includes plural input devices, (e.g., keyboard 122 and mouse 124), and a display card 1 10 for controlling a monitor 120. Additionally, the computer 100 may include a floppy disk drive 114; other removable media devices (e.g. compact disc 119, tape, and removable magneto-optical media (not shown)); and a hard disk 112 or other fixed high density media drives, connected using an appropriate device bus (e.g., a SCSI bus, an Enhanced IDE bus, or an Ultra DMA bus). The computer may also include a compact disc reader 118, a compact disc reader/writer unit (not shown), or a compact disc jukebox (not shown), which may be connected to the same device bus or to another device bus.

As stated above, the system includes at least one computer readable medium. Examples of computer readable media are compact discs 119, hard disks 112, floppy disks, tape, magneto-optical disks, PROMs (e.g., EPROM, EEPROM, Flash EPROM), DRAM, SRAM, SDRAM, etc. Stored on any one or on a combination of computer readable media, the present invention includes software for controlling both the hardware of the computer 100 and for enabling the computer to interact with a human user. Such software may include, but is not limited to, device drivers, operating systems and user applications, such as development tools. Such computer readable media further includes the computer program product of the present invention for performing the inventive method herein disclosed. The computer code devices of the present invention can be any interpreted or executable code mechanism, including but not limited to, scripts, interpreters, dynamic link libraries, Java classes, and complete executable programs. Moreover, parts of the processing of the present invention may be distributed for better performance, reliability, and/or cost.

The invention may also be implemented by the preparation of application specific integrated circuits or by interconnecting an appropriate network of conventional component circuits, as will be readily apparent to those skilled in the art.

Obviously, numerous modifications and variations of the present invention are possible in light of the above teachings. It is therefore to be understood that within the scope of the appended claims, the invention may be practiced otherwise than as specifically described herein.

What is claimed is:

1. A method for teaching sound/symbol correspondences in alphabetically represented languages comprising:
selecting an alphabetic character string;
choosing a tangible representation of a sound that the alphabetic character string is used to represent; and
associating the tangible representation with the alphabetic character string based on a probability that the alphabetic character string is used in a word to represent the sound represented by the tangible representation.

2. The method according to claim 1, wherein said choosing comprises choosing a plurality of tangible representations each corresponding to a sound that the alphabetic character string is used to represent.

3. The method according to claim 2, wherein the associating includes providing a multi-sided object with the alphabetic character string on one side and the tangible representations on respective different sides of the multi-sided object.

4. The method according to claim 3, wherein the plurality of tangible representations represent at least two different sounds that the alphabetic character string is used to represent.

5. The method according to claim 4, wherein said associating comprises providing a same tangible representation on a number of different sides of the object based on the probability that the alphabetic character string is used in a word of an alphabetically represented language to represent the sound represented by the same tangible representation.

6. The method according to claim 5, wherein a largest number of the plurality of different sides of the multi-sided object sharing the same tangible representation corresponds to the tangible representation representing the sound of the alphabetic character string with the highest probability of use in the alphabetically represented language.

7. The method according to claim 3, wherein the associating comprises providing on each side a number representing the probability that the alphabetic character string is used in a word to represent the sound of the tangible representation on that side.

8. The method according to claim 3, wherein the multi-sided object is a cube.

9. The method according to claim 3, wherein the alphabetic character string and the plurality of tangible representations on different sides of the multi-sided object can each be detected visually, or tactilely or obht visually and tactilely.

10. The method according to claim 1, wherein the associating is done electronically.

11. The method according to claim 2, wherein the associating includes displaying the alphabetic character string along with at least one of the tangible representations.

12. The method according to claim 11, wherein the displaying displays the at least one of the plurality of tangible representations based on the probability that the alphabetic character string is used in a word to represent the sound represented by the at least one tangible representation.

13. The method according to claim 12, wherein the display size of the at least one tangible representation is related to the probability that the selected alphabetic character string is used in a word to represent the sound represented by the at least one tangible representation.

14. The method according to claim 12, wherein the displaying displays a chart including all of the plurality of tangible representations of sounds related to the selected alphabetic character string, wherein
the chart is divided into sections indicating the probabilities that the selected alphabetic character string is used in a word to represent the sound represented by each of the plurality of tangible representations.

15. The method according to claim 11, wherein the associating includes auditorily presenting a probability that the alphabetic character string is used in a written word to represent the sound represented by the at least one of the tangible representation.

16. The method according to claim 14, wherein the auditorily presenting includes presenting the probability by varying at least one of loudness, repetitions, and auditory instructions.

17. A computer program product storing computer program instructions which when executed by a computer cause performance of the method recited in claim 1.

18. A system for using tangible representations of sounds to teach sound/symbol correspondences in alphabetically represented languages comprising:
a memory configured to store data for facilitating the teaching of sound/symbol correspondences in alphabetically represented languages;
a processor configured to:
select an alphabetic character string;
choose a tangible representation of a sound the alphabetic character string is used to represent; and
associate the tangible representation with the alphabetic character string based on the probability that the alphabetic character is used in a word to represent the sound represented by the tangible representation; and
a display configured to display the alphabetic character and a result of the association by the processor.

19. The system according to claim 18, wherein the result of the association is a chart including a plurality of tangible representations of sounds related to the selected alphabetic character string, wherein
the chart is divided into sections indicating the probabilities that the selected alphabetic character string is used in a word to represent the sound represented by each of the plurality of tangible representations.

20. The system according to claim 18, further comprising speakers configured to auditorily present the probability that the alphabetic character string is used in a word to represent the sound represented by the tangible representation.

21. A method for teaching sound symbol correspondences in alphabetically represented languages comprising:
selecting a sound;
choosing from an alphabetically represented language an alphabetic character string used to represent the sound; and
associating the alphabetic character string with the sound based on a probability that the alphabetic character string is used in a word of the alphabetically represented language to represent the sound.

22. The method according to claim 21 wherein said choosing comprises choosing a plurality of alphabetic character strings each corresponding to the sound.

23. The method according to claim 22, wherein the associating includes providing a multi-sided object with the sound represented on one side and the alphabetic character strings provided on respective different sides of the multisided object.

24. The method according to claim 23, wherein the sound is represented by a tangible representation.

25. The method according to claim 23, wherein the plurality of alphabetic character strings includes at least two different character strings used to represent the sound.

26. The method according to claim 24, wherein said associating comprises providing a same character string on a number of different sides of the object based on the probability that the alphabetic character string is used in a word to represent the sound.

27. The method according to claim 22, wherein the associating includes auditorily representing the sound along with a display of at least one of the alphabetic character strings.

28. The method according to claim 27, wherein the displaying displays the at least one of the plurality of alphabetic character strings based on the probability that the alphabetic character string is used in a word to represent the sound.
